(19) United States
(12) Patent Application Publication
(10) Pub. No.: US 2007/0244290 A1
(43) Pub. Date: Oct. 18, 2007

(54) POLYURETHANES FOR MEDICAL IMPLANTATION

(76) Inventor: John SWANSON, Portland, OR (US)

Correspondence Address: ADVANCED NEUROMODULATION SYSTEMS, INC., 6901 PRESTON ROAD, PLANO, TX, 75024, US

(21) Appl. No.: 11/696,419

(22) Filed: Apr. 4, 2007

Related U.S. Application Data
(60) Provisional application No. 60/789,515, filed on Apr. 5, 2006.

(51) Int. Cl. C08G 18/00

(52) U.S. Cl. 528/44

(57) ABSTRACT

A polyurethane material is provided that reduces or eliminates the need for use of polycarbonates and improves biostability of the polyurethane material while maintaining preferred physical properties. This polyurethane material is comprised of a hard block segment, such as methylene diphenyl diisocyanate (MDI), a phenol-based silicone soft segment and preferably includes a chain extender, such as butanediol. This polyurethane material is particularly useful for medical implantation applications, especially with respect to coatings for lead and assemblies.

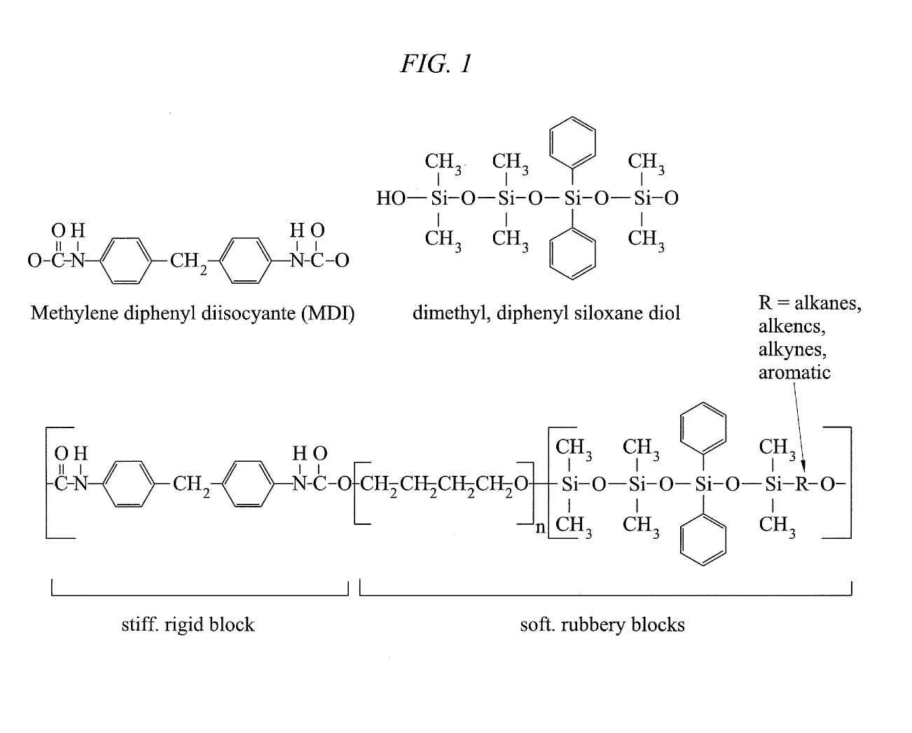

### RELATED APPLICATIONS

This application claims the benefit of U.S. Provisional Patent Application Ser. No. 60/789,515, entitled “POLYURETHANES FOR MEDICAL IMPLANTATION,” filed Apr. 5, 2006, which is incorporated herein by reference.

### TECHNICAL FIELD

The present application relates generally to polymeric compositions of matter and more particularly to polymeric compositions for medical implantation.

### BACKGROUND

Many polymers have characteristics making them useful for medical implantation applications. The chemistry of the repeat unit, the shape of the molecular backbone, and the intermolecular bonds that make up the polymer all have an effect on the ultimate properties. These polymers can have interesting permeability properties and biocompatibility, and the polymer's molecular weight distribution and its average molecular weight also can have an effect on the polymer properties. In block copolymers, a hard, high-melting block segment can be copolymerized with a soft, rubbery block segment. With the proper arrangement of the block segments, the copolymer formed can be a thermoplastic elastomer. The soft block segments are strengthened and reinforced by the hard block segments at room temperature. At higher temperatures, these hard block segments can soften and flow to permit thermoplastic processing. When cooled, the original structure re-forms. Thermoplastic polyurethanes have this block, or segmented, structure.

These thermoplastic polyurethanes have been used in the past for medical implant applications. Polyurethanes formed in this manner, however, degraded in the body over time, and it was determined that it was the polyester typically contained within these polyurethanes that attributed to increased degradation. So as to address the issue of degradation, polyurethanes were then modified to eliminate the polyester component by substituting a polyether. This polyurethane incorporating a polyether achieved greater stability when implanted in the body. However, the polyurethane still would degrade.

Over time, the polyether component of the polyurethane has been replaced with a polycarbonate soft segment. Polycarbonates (R—O—(CO)—O—R) are oligomeric or polymeric materials where difunctional alcohols are linked via a difunctional carbonate group. Such polycarbonates are typically soft and relatively hydrophobic. The resulting polyurethane material achieved more stability when implanted within the body and lasted longer but would still ultimately degrade over time. An example would be a polycarbonate-urethane formed as the reaction product of a hydroxyl-terminated polycarbonate and an aromatic diisocyanate, where a low molecular weight glycol may be used as a chain extender. Thus, in this type of material, the hard segment is methylene diphenyl isocyanate (MDI) and the polycarbonate is the soft segment.

In developing a biopolymer for medical implantation, a material having a relatively low durometer is desirable. As more soft segment is added to the polymeric material, the durometer typically drops and the material degrades at a faster rate. For example, more polycarbonate may be added to drop the durometer. However, this material will typically degrade at a faster rate because of the additional polycarbonate. Thus, a need exists to form a soft segment material containing little or no polycarbonate.

With respect to long-term implantation of these biopolymers, the industry has recently focused on the use of silicones. However, it is generally understood that polyurethanes would be preferable for use, as compared to silicones, due to their ease in use for thermoplastic processing, their higher tear strength, their low modulus, abrasion resistance and their high ultimate tensile strength. A variation of a polycarbonate-urethane, wherein a portion of the polycarbonate soft segment is replaced with a silicone, may achieve additional improvements in stability. However, as polycarbonate is still present in the polyurethane material formed, the material does tend to degrade but at a slower rate. Thus, full stability is not achievable, and degradation in the body occurs due to the continued presence of the polycarbonate in this polyurethane material. Further, use of silicone chain extenders in these polyurethane materials typically results in a material having a cloudy appearance indicating increased crystallinity and phase separation between the hard block and soft block segments. Therefore, there is a need for a polyurethane material for long-term medical implantation applications, providing for improved biostability of the polyurethane material while maintaining preferred physical properties.

### SUMMARY

Some representative embodiments are directed to a polyurethane material for use in medical implantation comprising a hard block segment and a soft block segment wherein said soft block segment does not include a polycarbonate. Preferably, the soft block segment is comprised of at least a dimethyl, diphenyl siloxane diol. The soft segment preferably may further include a chain extender bridging the hard block segment and the dimethyl, diphenyl siloxane diol. Such a material is preferably more stable and has a better affinity to the solvent used in the synthesis process in conjunction with the aromatic isocyanate. Articles which may be formed from the polyurethane material of embodiments of the invention include, but are not limited to, the polymer component of a lamitrode or the end of an electrode assembly for neuro-spinal stimulation, a neuro-spinal stimulation lead, a cardiac defibrillator lead, a pacemaker, an epilepsy mapping electrode, or an artificial disk implant.

Some representative embodiments are further directed to a method of increasing the biostability of biocompatible polyurethane. This method includes at least the steps of forming a soft segment of said polyurethane using a phenol-based silicone and attaching the soft segment to a hard segment utilizing a chain extender, wherein said soft segment does not include a polycarbonate. The method may further comprise fluorinating an end cap of the biocompatible polyurethane. Other embodiments preferably include adding at least one additional bioactive compound to an end cap of the biocompatible polyurethane and adding at least one branching group to the biocompatible polyurethane. By adding additional bioactive compounds and branching groups, improvement in the biostability of the biocompatible polyurethane is preferably achieved.

Some representative embodiments also provide for polyurethane material comprising a phenol-based silicone soft segment that eliminates use of polycarbonates and preferably improves biostability of the polyurethane material while maintaining preferred physical properties. The polyurethane material preferably is further comprised of a chain extender between the phenol-based silicone soft segment and the hard segment forming the polyurethane material. The phenol-based silicone soft segment may be further comprised of branching groups selected from the group consisting of alkanes, alkenes, alkynes or aromatic groups. By improving affinity, more opportunity is given to break up the crystallinity which preferably improves the physical properties of the material to be used in medical implantation processes.

The foregoing has outlined rather broadly certain features and/or technical advantages in order that the detailed description that follows may be better understood. Additional features and/or advantages will be described hereinafter. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the spirit and scope of the appended claims. The novel features, both as to organization and method of operation, together with further objects and advantages will be better understood from the following description when considered in connection with the accompanying figure. It is to be expressly understood, however, that the figure is provided for the purpose of illustration and description only and is not intended as a definition of the limits of the appended claims.

### BRIEF DESCRIPTION OF THE DRAWINGS

The FIGURE depicts the structure of a typical polymer having a dimethyl, diphenyl siloxane diol soft segment.

### DETAILED DESCRIPTION

Some representative embodiments provide a polyurethane having a stiff, rigid block segment and a soft, rubbery block segment (as shown in the FIGURE). The structure of the novel polymeric material having a methylene diphenyl diisocyanate (MDI) hard segment, a phenol-based silicone soft segment and a butanediol chain extender is depicted in the embodiment shown in the FIGURE. The stiff, rigid block segment is comprised of MDI. In alternative embodiments, however, other isocyanates may be substituted for MDI. The soft, rubbery block segment is comprised of dimethyl, diphenyl siloxane diol as well as a chain extender (shown in the FIGURE as butanediol). Each of these components of the formed polyurethane material shall be discussed in detail below.

In the embodiment shown in the FIGURE, MDI is utilized as the hard segment for formation of the polyurethane material. MDI achieves stability in the body as it is the rigid component of the urethane. Although the FIGURE describes the polyurethane utilizing MDI, it should be appreciated that other isocyanates may be utilized according to alternative embodiments. For example, to achieve a more rigid hard segment, a methyl group may be eliminated to bring the aromatic groups together, resulting in the use of naphthalene diisocyanate as the hard segment, which preferably further improves segment stability. Other embodiments of the hard segment may preferably include, but are not limited to, diphenyl diisocynate or methylene bis-(4-cyclohexylisocyanate) (HMDI).

In the embodiment depicted in the FIGURE, bridging the MDI hard segment and the dimethyl, diphenyl siloxane diol soft segment is a butanediol chain extender. Butanediol is a chain extender that attaches the hard segment with the other component of the soft segment (dimethyl, diphenyl siloxane diol). In place of butanediol, the chain between the hard segment and the soft segment could also preferably be extended by using other diols, including but not limited to, hexanediol, pentanediol, septanediol and octanediol. Although the chain may be extended to a length greater than that of octanediol, it should be appreciated that there will reach a point where the chain will become too long causing less desirable properties for injection molding and extrusion processing. It should be appreciated, however, that by using different types of chain extenders, the structural properties of the base polymer, polyurethane, may be varied depending on the end use of the material.

Dimethyl diphenyl siloxane diol has been utilized as a component of the soft segment for the polyurethane material contemplated by the present invention, as it is a material that is more soluble when combined with MDI. It is an aromatic group which has affinity for the aromatic urethane. The aromatic group is known for having improved stability, but by having the dimethyl group present, the qualities befitting a soft segment component are still available. The ratios of these components may be altered, but the stability remains relatively constant and the affinity is improved. Further, by having additional aromaticity in the soft segment, it becomes easier to laser ablate during the fabrication process because the UV absorption of the polyurethane material is improved. Silicone alone does not provide this feature as it does not exhibit much UV absorption in the manner desired; however, with the addition of aromatic groups, the absorption of the polyurethane material is substantially improved.

Another advantage in adding aromaticity into the soft segment, where aromaticity has not been present before, is that more affinity between the soft and the hard block segments may be achieved. As more affinity is added, more opportunity is given to break up the crystallinity which may improve the overall properties of the material. As shown in the FIGURE, the variable “n” has been included as part of the soft, rubbery block to indicate that additional chain extenders may be added.

Similarly, the variable “R” has been included with the dimethyl, diphenyl siloxane diol soft segment indicating that alkanes, alkenes, alkynes and other aromatic groups may be added to that particular branch of the soft segment. Additionally or alternatively, side branches may be appended to the each of the methyl groups of the dimethyl, diphenyl siloxane diol soft segment. Accordingly, branching does not have to take place solely in the backbone; rather, the side chains also may be branched. In doing so, however, the density of the polymer is reduced. Further, improvements in mild stabilities may be achieved by fluorinating the end cap, for example. By doing so, the bulk properties of the polyurethane material are not affected, but the fluorinated groups close to the surface of the bulk material will move to the outside of the bulk material which will further improve the biostability of the material. Additionally or alternatively, if bioactive compounds are desirable on the end cap, these compounds may be added without concern of them leaching away when they are covalently bonded. Other options include adding branching groups to make the material more hydrophobic or hydrophilic at the surface.

By adding aromatic groups in different locations, the properties of the resulting polyurethane may be affected depending on the manner in which the polyurethane is to be utilized. If side chain extenders are included and extended out, as has been previously discussed, then the density of the resulting polyurethane material may decrease. This may be desirable for some applications. For example, if the material is to take on the properties of a membrane, then a more open pore structure would be desirable, and for use, the side chains may be altered to further open the structure.

Although the density varies depending on the level of branching employed, it should be appreciated that overall a particular molecular weight may be selected for the polyurethane material, depending on the use desired for the polyurethane material. For example, for use of the polyurethane in an extrusion process, a molecular weight from 150,000 Daltons molecular weight up to as high as 600,000 Daltons molecular weight is preferably selected. It should be appreciated that although it is possible to increase the molecular weight to above 600,000, challenges in processing arise as the molecular weight increases. Therefore, processing may set limits as to what molecular weight is utilized for a particular application.

There are many features of this new polyurethane material that improve over prior art polyurethanes. This polyurethane preferably reduces biodegradation of oxygen free radicals promoted by adherent macrophages and foreign body giant cells (FBGC). This polymer structure is preferably more bio-stable, as the durometer increases, as compared to the prior art materials, such as silicone polyurethane. The polyurethane material may then last longer in the body with less attack and consequently less damage to the material and to the body itself.

This new polyurethane material preferably reduces the phase separation between the hard and soft block segments, allowing the soft block segment to provide a more significant contribution to the physical properties. There are times that, if the phase separations are strong, large soft block and hard block segments result, and the hard blocks have large phase separations. The soft block segments will have elasticity, but the hard block segments do not contribute any elasticity. Rather, the hard block segments act more like fillers that may result in overall weakening of the polymer. Accordingly, this new polyurethane material allows for both the soft block and the hard block segments to contribute, wherein both types of segments are active players in the resulting material.

This new polyurethane material dramatically increases the UV absorption in the soft segment to further increase laser machinability and laser machine uniformity as well as reduce laser time. Lasers are used for fabrication of medical devices where the use of wavelengths that absorb in the UV region is required, and standard silicones do not provide for good absorption in this UV region. As aromatic groups are added to these standard silicones, more absorption will result, allowing laser ablation to occur more easily. This results in more control in the cutting process.

Further, the new material allows for improved temperature and chemical stability. As aromaticity is added, the stability of the electronic configuration against attack improves. Further, addition of the aromatic groups makes the material more thermally stable at both low and high temperatures.

Another feature of the new material is the reduction or elimination of stickiness or tackiness issues observed in the lower durometer polycarbonate-based polyurethanes. Problems have arisen with these polycarbone-based materials with the tackiness that occurs after extrusion when the material is spooled. This extrusion occurs over a wire, wherein the wire is spooled. After the wire is spooled, if an attempt is made to unspool the coated wire, this coated wire will adhere to itself, having a tackiness as if it acquires the properties of a tape-like material. It is believed that a portion of this tackiness property originates based on the presence of a polycarbonate within the polyurethane material. By eliminating the use of polycarbonates, tackniness also may be eliminated in the polyurethane material.

The new material further provides for improved solubility of the modified silicone in the urethane coreactants. There may be problems with hard block and soft block segments when the solvent used is compatible with the hard block segment but much less compatible with the soft block segment. When this occurs, it presents a challenge to work in a medium where both hard block and soft block segments provide good solubility. By adding aromaticity, improvement in the solubility compatibility between the hard block and soft block segments results.

It should be appreciated that as there are hard block and soft block segments in this polyurethane material, the ratios of the two segments may be altered. In some embodiments of the invention, more soft-block segments may be added to result in a more biostable material. The polymer industry has had difficulty in achieving this goal of biostability, with the exception of using silicone. However, as standard silicones are not thermoplastics, they cannot be extruded in a typical extruder to be used for medical implantation processes. Rather, specialized extruders must be used for these silicones, such that the material is cured using an oven once extruded in order for it to become a thermoset. Therefore, these silicones have not been preferable in terms of manufacturability. Further, silicones have low abrasion resistance and poor tear strength. This new polyurethane material will allow a reduction in durometer, while providing ease of manufacturing in that normal extrusion processes may be utilized as the tear strength of this polyurethane material is higher than silicone. Biocompatibility is retained, and additional strength is gained.

In some representative embodiments, the use of the present polyurethane material occurs in medical leads of neurostimulation systems. A neurostimulation system typically includes an implantable pulse generator that is electrically coupled to one or several leads. The pulse generator is the device that generates the electrical pulses. The pulse generator is typically implanted within a subcutaneous pocket created under the skin by a physician. The leads (and sometimes with lead extensions) are used to conduct the electrical pulses from the implant site of the pulse generator to the targeted nerve tissue. In representative embodiments, the leads include a lead body of the present polyurethane material with embedded wire conductors extending through the lead body. Each wire is electrically isolated thereby providing an independent channel for conduction of electrical pulses. Electrodes on a distal end of the lead body are coupled to one or several conductors to deliver the electrical pulses to the appropriate nerve tissue. By utilizing the present polyurethane material, leads of neuromodulation systems preferably will experience greater biostability and exhibit superior manufacturing properties. Although neurostimulation has been discussed according to some representative embodiments, other electrical stimulation systems can utilize medical leads manufacturing using the present polyurethane material such as implantable cardiac defibrillator systems, cardiac pacing systems, gastic pacing systems, etc.

In some representative embodiments, medical leads can be fabricated by employing one or several extrusion operations utilizing the present polyurethane material. In one embodiment, the formation of a lead body begins when an inner insulative wall is formed by extruding the present polyurethane material over a mandrel. Conductors are preferably helically wound around the inner insulative wall. Another insulative layer of the present polyurethane material is extruded over the wound conductors. Another layer of conductors could be wound over the second insulative layer and followed by extrusion of a third insulative layer of the present polyurethane material. A heating process (e.g., using a reflow oven) can be used to fuse all of the insulative material into a solid fused matrix or monolithic mass. The fused matrix of material electrically isolates the conductors from bodily tissue and fluids when implanted and electrically isolates each conductor from the other conductors. Electrodes can be formed on the lead body by laser ablating through the insulative layer to create small openings to each conductor. Conductive material is provided within the small openings and ring electrodes are formed or placed in such a manner to be electrically coupled to the conductive material in the small openings. In alternative embodiments, the present polyurethane material can also be used in the paddle structure of a laminotomy lead in addition to the lead body coupled to the paddle structure.

Another application of this polyurethane material would preferably be for the polymer component of a lamitrode or the end of an electrode assembly or lead body for different types of neuro-spinal stimulation. The polyurethane material may be inserted into the brain for uses such as treatment of Parkinson's Disease or Essential Tremor. Other applications may include use for treatment of temporomandibular joint diseases and disorders (TMJ), facial pain, for appetite suppression, or depression.

Other uses of this material are preferably as cardiac defibrillator leads, pacemakers, as well as epilepsy mapping electrodes and nerve cuff electrodes. If a harder material is used, such as one including more urethane and less silicone, the polyurethane material is preferred for these applications. The polyurethane material may further be used for artificial disk implants.

Although representative embodiments and advantages have been described in detail, it should be understood that various changes, substitutions and alterations can be made herein without departing from the spirit and scope of the appended claims. Moreover, the scope of the present application is not intended to be limited to the particular embodiments of the process, machine, manufacture, composition of matter, means, methods and steps described in the specification. As one of ordinary skill in the art will readily appreciate from this disclosure, processes, machines, manufacture, compositions of matter, means, methods, or steps, presently existing or later to be developed that perform substantially the same function or achieve substantially the same result as the corresponding embodiments described herein may be utilized without departing from the scope of the appended claims. Accordingly, the appended claims are intended to include within their scope such processes, machines, manufacture, compositions of matter, means, methods, or steps.

1. A polyurethane material for use in medical implantation comprising:
a hard block segment; and
a soft block segment wherein said soft block segment is comprised of at least a dimethyl, diphenyl siloxane diol.

2. The polyurethane material of claim 1 wherein said hard block segment is selected from the group consisting of methylene diphenyl diisocyanate (MDI), methylene bis-(4-cyclohexylisocyanate) (HMDI), and diphenyl diisocyanate.

3. The polyurethane material of claim 1, wherein said soft block segment is further comprised of a chain extender bridging said hard block segment and said dimethyl, diphenyl siloxane diol of said soft block segment.

4. The polyurethane material of claim 3, wherein said chain extender is butanediol.

5. The polyurethane material of claim 1, said dimethyl, diphenyl siloxane diol further comprising a branching component.

6. The polyurethane material of claim 5 wherein said branching component is selected from the group comprising:
alkanes, alkenes, alkynes and aromatic compounds.

7. A method of increasing the biostability of biocompatible polyurethane/said method comprising:
forming a soft segment of said polyurethane using a phenol-based silicone, wherein said soft segment does not include a polycarbonate; and
attaching said soft segment to a hard segment utilizing a chain extender.

8. The method of claim 7 wherein said chain extender is selected from the group comprising: pentanediol, hexanediol, septanediol and octanediol.

9. The method of claim 7 wherein said phenol-based silicone is dimethyl, diphenyl siloxane diol.

10. The method of claim 7, wherein said hard segment comprises methylene diphenyl diisocyanate (MDI).

11. The method claim 7 further comprising:
fluorinating an end cap of said biocompatible polyurethane.

12. The method of claim 7 further comprising:
adding at least one additional bioactive compound to an end cap of said biocompatible polyurethane.

13. The method of claim 7 further comprising:
adding at least one branching group to said biocompatible polyurethane.

14. A polyurethane material comprising a phenol-based silicone soft segment that eliminates use of polycarbonates and improves biostability of said polyurethane material while maintaining the desired physical properties.

15. The polyurethane material of claim 14 further comprising:
a chain extender between said phenol-based silicone soft segment and a hard segment forming said polyurethane material.

16. The polyurethane material of claim 14, said phenol-based silicone soft segment further comprising:
branching groups selected from the group consisting of alkanes, alkenes, alkynes or aromatic groups.

17. The polyurethane material of claim 16 wherein said phenol-based silicone soft segment is dimethyl, diphenyl siloxane diol.

18. The polyurethane material of claim 16 wherein said branching groups are attached to at least one of the methyl groups comprising said dimethyl, diphenyl siloxane diol.

19. The polyurethane material of claim 14 wherein the percentage by weight of said soft segment is greater than the percentage by weight of said hard segment.

20. The polyurethane material of claim 14 wherein the percentage by weight of said hard segment is greater than the percentage by weight of said soft segment.

21-32. (canceled)
